(19) United States
(12) Patent Application Publication
(10) Pub. No.: US 2023/0169534 A1
(43) Pub. Date: Jun. 1, 2023

(54) Predicting a Propensity for Referral

(71) Applicant: Mention Me Limited, London (GB)

(72) Inventors: Timothy James Boughton, London (GB); Andrew Cockburn, London (GB)

(21) Appl. No.: 18/048,465

(22) Filed: Oct. 21, 2022

Related U.S. Application Data
(60) Provisional application No. 63/264,714, filed on Dec. 1, 2021.

(51) Int. Cl. G06Q 30/02

(52) U.S. Cl. CPC G06Q 30/0214; G06Q 30/0204

(57) ABSTRACT

Method and systems, including a computer program product, for segmenting customers. A customer is selected from a set of customers associated with a merchant. A propensity to refer score is determined for the selected customer. The customer is associated with a customer segment among two or more customer segments. The associating is done at least in part based on the propensity to refer score. A customized message is provided to the customers in at least one customer segment.

### BACKGROUND

This invention relates to information processing. Specifically, this invention relates to information processing methods for marketing to customers, using a referral process and system.

A common problem encountered by merchants is the difficulty to find new customers in a cost-effective way. One way of finding new customers involves offering rewards to existing customers for encouraging their friends to become new customers. This is typically referred to as a Referral Program. Many companies around the world run different kinds of Referral Programs.

However, merchants face the challenge of not knowing whether a customer who is being asked to refer a product or service to a friend is actually likely to do so. If a referral message is sent to an existing customer who is unlikely to want to refer products and/or services to their friends, then the merchant has not effectively marketed to that customer. There may be other goals (e.g., loyalty, repeat purchasing, newsletter sign up or merchant-specific objectives) which could be better served, or which may lay the groundwork for improving the chance of referral later. For similar reasons, it might also be useful to segment existing customer referral programs into those customers who are likely to refer products and/or services to their friends, and those who need more encouragement. Doing so can be a good way for the merchant to improve conversion rates or improve their overall margin.

In current customer referral systems, this process is done manually. That is, typically a merchant sets up an initial set of rules. For example, the merchant may send a marketing message to 50% of its customers, offering them a $50 rebate on the next purchase if they refer a friend. The remaining 50% of its customers may instead receive a message offering them a 25% rebate on their next purchase. Once the general rules have been set by a merchant, the merchant can evaluate over time how the customers have engaged with the different marketing messages, and then the merchant can manually change the percentages of customers who get the different types of incentives to try to obtain even better results.

The process of determining which type of message to serve to a cohort of the merchant's customers is manual in so far as it is not able to split the cohort of the merchant's customers into appropriate segments to then determine which ones should receive a refer-a-friend message and which ones should not receive a refer-a-friend message. The manual nature of this process makes the process not only time-consuming and prone to human errors, but it may also involve significant personal judgment about expectations on how certain customers would behave, which may not reflect their actual behavior. Thus, there is a need for an improved referral system that is more efficient, less error-prone, fact-based, and free of personal bias.

### SUMMARY

According to one aspect of the present invention, methods, systems and computer program products are provided that allow a merchant to identify how likely a customer is to refer a friend to the merchant, based on a model which uses various types of data that the merchant has collected for that customer.

In some aspects, the techniques described herein relate to a segmentation method, including: selecting a customer from a set of customers associated with a merchant; determining a propensity to refer score for the selected customer; associating the customer with a customer segment among two or more customer segments, wherein the associating is done at least in part based on the propensity to refer score; and providing a customized message to the customers in at least one customer segment.

In some embodiments, different customer segments can be provided with differently customized messages, and the customized messages can be intended to encourage the customers in the customer segment to take an action.

In some embodiments, the propensity to refer score can represent a likelihood for the customer to refer another potential customer to a merchant.

In some embodiments, the propensity to refer score can be based on data collected from several data sources and can be representative of one or more of: the customer's purchase history, the customer's demographic, the customer's psychographic and the customer's psychological behavior.

In some embodiments, the data sources can include order data, device data, personally identifiable information, observed data, and/or other customer behavioral data.

In some embodiments, the method can include evaluating an impact on the customers' behaviors from the customized message sent to the at least one customer segment, with respect to a customer control group, and changing the contents and/or format of the customized message to influence the customers' behaviors in response to the customized message.

In some embodiments, the method can include providing a reward to a customer in response to the customer performing an action specified in the message.

In some embodiments, the action specified in the message can be to refer a potential customer to a merchant, and the potential customer can also be provided with a reward.

In some embodiments, machine learning techniques can be used to determine the propensity to refer score.

In some aspects, the techniques described herein relate to a system for segmenting customers. The system includes a processor and a memory storing instructions that when executed by the processor cause the processor to perform the following operations: selecting a customer from a set of customers associated with a merchant; determining a propensity to refer score for the selected customer; associating the customer with a customer segment among two or more customer segments, wherein the associating is done at least in part based on the propensity to refer score; and providing a customized message to the customers in at least one customer segment.

In some aspects, the techniques described herein relate to a computer program product for segmenting customers, comprising a non-transitory computer readable storage medium containing instructions that when executed by a processor cause the processor to: select a customer from a set of customers associated with a merchant; determine a propensity to refer score for the selected customer; associate the customer with a customer segment among two or more customer segments, wherein the associating is done at least in part based on the propensity to refer score; and provide a customized message to the customers in at least one customer segment.

The details of one or more embodiments of the invention are set forth in the accompanying drawings and the description below. Other features and advantages of the invention will be apparent from the description and drawings, and from the claims.

### BRIEF DESCRIPTION OF THE DRAWINGS

FIG. 1 shows a first system in which the methods and systems of the invention can be implemented, in accordance with a first embodiment.

FIG. 2 shows a second system in which the methods and systems of the invention can be implemented, in accordance with a second embodiment.

FIG. 3 is a flowchart showing a method for predicting a propensity for referral, in accordance with one embodiment.

Like reference symbols in the various drawings indicate like elements.

### DETAILED DESCRIPTION

### Overview

As was mentioned above, the general concept of referral programs is well known. However, the various embodiments described herein expands on the general referral program concept, by allowing referral data to be used at scale in order to make predictions relevant to improving future conversion rates or goals for a merchant.

According to one aspect of the present invention, methods, systems, and computer program products are provided that allow a merchant to identify how likely a customer is to refer a friend to the merchant, based on a model which uses various types of data that the merchant has collected for that customer.

In particular, the various embodiments of the present invention make it possible for a merchant to predict, in a data-informed manner, how likely it is that a customer will engage with a refer-a-friend marketing communication from the merchant. This is accomplished by analyzing the data held by the merchant on the individual customer, and then ascribing that individual a “propensity to refer score,” which is subsequently used by the merchant to decide whether to send that individual a refer-a-friend marketing communication or send them something else more valuable for that customer and merchant.

On a general level, the various embodiments of the invention work as follows. A merchant operates a referral program and collects detailed data about the participants in the referral program, i.e., builds a representation of how individual customers behave. In some embodiments, the data is collected by the merchant itself, and in other embodiments, the data is collected and processed by an intermediary agent, which in turn, provides the processed data (i.e., the representation of the customer's behavior) to the merchant, as will be described in further detail below. The size of the data set is typically very large and can include millions of rows of customer level insights. The merchant or intermediary agent, depending on the embodiment, processes the data set, using various machine learning steps, to train a suitable model. In some embodiments, the model is a classifier model (that puts customers into clusters/classifications based on their data attributes) or a recommender model (that makes a recommendation about the next action to take given the data attributes), or even a recommender model which seeks to establish cause and effect of a recommended action. A held back test set of data can be used to determine the model's precision and accuracy and these can be related to the commercial outcomes which could be obtained if applied to a group of customers. Generally, different merchants have their own models, since the variability of customers, products, services, geographical location, etc., tends to vary widely between different merchants, which makes it difficult or impossible to find a “one-size-fits-all” type of solution that is highly accurate.

Once the model has been created and its initial precision and accuracy has been determined, the model is optimized for the appropriate precision and accuracy. Once the model has been optimized, the model is inserted into the existing segmentation or decision making part of the referral program in such a way that by selecting which customer is enrolled in which referral offer (or shown an alternative offer) the model confers a commercial advantage of some sort to the merchant (e.g. driving up revenue, improving conversion, improving margin or driving up the volume of new customers added)—through better segmentation or goal-optimization. That is, the referral program is provided with the ability to be segmented according to a likelihood to refer—such that the blended average conversion rate across all the segments is greater than the conversion rate of a single larger segment. Effectively this allows the targeting of specific referral messaging and rewards at customer segments to whom they appeal most. Also, targeting of customer segments who are not willing or able to refer can also be done, such that another complementary revenue goal of the merchant (for example repeat purchase or newsletter sign up) can be achieved with them without jeopardizing the existing referral revenue stream. In some embodiments, a control segment of say 5% is also retained, representing customers who do not receive any messages from the merchant, thereby allowing the merchant to evaluate how well the model works, and to decide whether or not to use the model or to retrain the model in the future.

These new and improved referral program techniques make it possible for a merchant to serve a message to a customer and predict with a higher level of accuracy than what is possible using existing methods, and using a data-informed manner, whether that customer is likely to refer new customers to the merchant. Having this prediction allows merchants to tailor a message to that customer. For example, if a customer has a high likelihood of referring new customers, then the merchant will send a referral message to that customer. On the other hand, if a customer has a low likelihood to refer new customers, then the merchant may send a different type of marketing message to that customer. As a result, the merchant is able to tailor messages to its customers and therefore increase the level of engagement with its customers. The financial benefit for the merchant of doing this is that the merchant is likely to receive a higher return on investment on its marketing promotions.

### Definitions

In order to facilitate the description and understanding of the various embodiments, the following terminology will be used throughout this document:

Merchant: An entity that is looking to encourage existing customers or entities to entice others to establish communication with the merchant and to perform a specified act.

Referral Program: A set of incentives, words, designs, and customer experiences established by a Merchant to encourage customers or entities to become referrers, and to encourage referred parties to complete a specified act. The Referral Program encompasses everything about the way the referral process operates and is operated for the merchant and customer, and can thus also include the merchant serving the customers “non-referral offers” (e.g., a message advertising the merchant's newsletter and asking for a sign-up or some other form of marketing message on behalf of a merchant).

Referred Party: An individual or entity that has established contact with a merchant as a result of an interaction with a referrer. Often this can be a friend of the Referrer.

Referrer: An individual or entity that advocates or promotes the Merchant's brand to their friends whether they have been informed about a Referral Program by a Merchant or not. Successful Referrers typically share details of the Referral Program with other individuals or entities and indirectly encourage them to become customers of the merchant.

Rewards: Incentives made available to both the Referrer and the Referred Party upon the completion of the Specified Act. Common examples of rewards include: a coupon code, cash, rebate, third party voucher, free product, free services, upgrades, virtual goods, charity donations and points (including the promise of these once the act is completed).

Specified Act: An action that the Merchant is willing to reward when a Referred Party establishes contact with the Merchant. One example of a Specified Act is for the referred party to be required to purchase something from the Merchant for the first time. Other examples of Specified Acts include various types of activities, such as registering, joining a membership or loyalty scheme, or signing up for a newsletter.

### ILLUSTRATIVE EXAMPLES

Various embodiments of the invention will now be described in further detail by way of example and with reference to the drawings. It should be noted that the embodiments described herein do not form an exhaustive list of all possible embodiments, but should rather be seen as representative examples. Many variations of parameters in these embodiments, as well as further embodiments, can be easily envisioned by those having ordinary skill in the art.

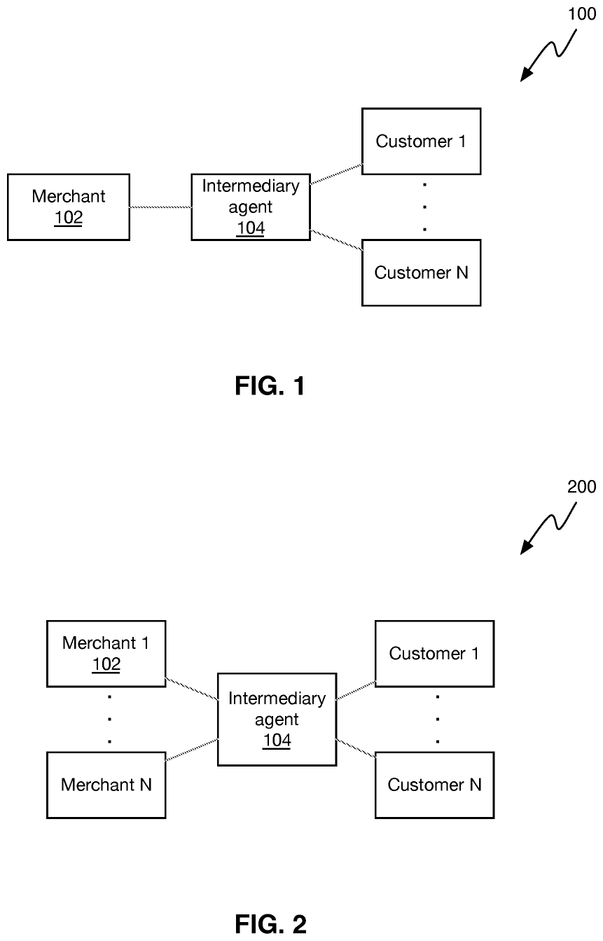

The referral program methods described herein can be implemented in a number of different environments. FIGS. 1 and 2 show schematic block diagrams of two such environments, in accordance with various embodiments of the invention. FIG. 1 shows a system 100, in which a single Merchant 102 has a number of customers, illustrated as customer 1 through customer N, some of whom may become Referrers, and some of whom may not. The customers can be individuals or entities (for example businesses, charities, or syndicates). The Merchant 102 communicates with the customers through an intermediary agent 104 (for example a 3^{rd} party platform dedicated to running, managing, and optimizing referral programs). In this embodiment, the data about the customers is collected and stored by the intermediary agent 104, which also builds the representations of the various customers' behaviors (for example storing facts about the customers' behavior, creating models of the predicted customer behavior and putting customers into groups according to their predicted behavior) and sends the outcome of those representations to the merchant 102 for onward use. The referral programs are conducted in entireties by the merchant 102. However, it should be realized that there are also embodiments in which the data collection, storage, and generation of customer behavior representations and referral programs are shared in various degrees between the merchant 102 and the intermediary agent 104, or even conducted entirely by the merchant 102. Thus, the embodiment shown in FIG. 1 should not be considered as a limitation as to how the invention can be practiced.

FIG. 2 shows an alternative environment 200, similar to that of FIG. 1, but in which multiple Merchants 102-N communicate through an intermediary agent 104 with multiple customers, again illustrated as customer 1 through customer N. Just like in FIG. 1, the customers can be individuals or entities. The data about the customers, merchants, and the interactions between the customers and merchants are stored by the intermediary agent 104. This data can then be used by the intermediary agent 104 to aid the different Merchants in making better decisions about what message, creatives (how the customer experience looks and behaves when the customer interacts with it), rewards, and/or configurations (how the referral program behaves under different circumstances and how much friction there is vs potential abuse) to serve their respective customers, in order to achieve the merchants' goals.

In contrast to the one-to-many communication of FIG. 1, the environment shown in FIG. 2 also allows many-to-many communication, so that any given customer may communicate with one or more merchants through the intermediary agent 104. As a result, a given customer may become a Referrer with respect to a subset of Merchants. Likewise, some customers may not become Referrers for any Merchants. This many-to-many configuration also allows for collaboration between merchants. For example, the intermediary agent 104 has the ability (with the merchants' permission) to combine data for an individual customer across their merchants, and thereby making a better prediction of the customer's likelihood to refer, based on a larger body of data. In some embodiments, this combining is not done at the level of an individual customer but at an aggregate level (for example using demographic or psychographic segments or by bucketing/clustering similar behaving customers together into groups who can be analyzed collectively), but even so, useful information can be gleaned about a customer's likelihood to refer. As the skilled person realizes, there are many variations that fall within the general concepts of this invention.

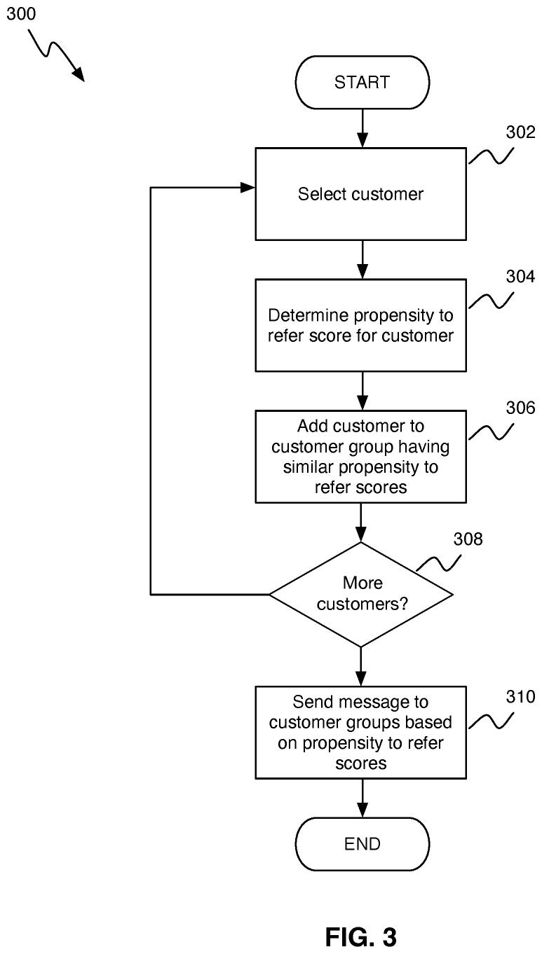

A referral program method in accordance with one embodiment will now be described in further detail with reference to the flowchart shown in FIG. 3. For simplicity, the method will be described in the context of the system 100 shown in FIG. 1, but it should be realized that the same method, and refinements thereof, can equally well be implemented on the intermediary agent 104 shown in FIG. 2. Also, it should be realized that there are further embodiments in which some functionality is conducted on the merchant 102 and some functionality is conducted on the intermediary agent 104. In yet further embodiments, the clients can perform some functionality, especially with respect to data collection and aggregation. Any such variations can be realized by a person having ordinary skill in the art.

As was mentioned above, the method uses data about customers to predict which customers are likely to refer their friends or acquaintances to the merchant. In some embodiments, the data collection is part of the method itself, but generally the data has been collected beforehand and saved by the merchant (or the intermediary agent 104) in an appropriate format that allows easy access and manipulation of the stored data. The customer data can include, for example, order data (e.g. how much of a particular product or products or service the customer ordered), device data (e.g. what device the customer was using when placing the order), personally identifiable information (e.g. the customer's name, which may indicate whether the customer is an organization or an individual, and possibly the individual's gender too), observed data (e.g., how the customer carries out specific tasks, how they interact with their device or the application of the merchant or intermediary agent, whether and how they share an offer with their friend), and other behavioral data (e.g. whether the customer has referred before or has been referred before, how the customer interacts with the merchant's website or products, how the customer has previously responded to any survey or to other forms of communication sent by the merchant or intermediary agent). Again, it should be noted that these are merely some examples of data that can be collected, and that the exact types of collected data is a design choice, depending on what information the merchant 102 or intermediary agent 104 may find useful, as well as various rules and privacy laws specific to where the parties operate, and a number of other factors.

Having this body of data, the method 300 starts as shown in FIG. 3 by the intermediary agent 104 selecting a customer, step 302. In most cases the customer “selects themselves” by virtue of turning up to a Merchant's web application and taking an action (e.g., browsing for a product or beginning to checkout or engaging in a particular customer experience). As was mentioned above, in some embodiments, the merchant may decide to perform the method for all their customers, but generally, a smaller “control segment” of customers is not selected, such that the effectiveness of the method 300 can be evaluated after some time. The control group is typically 5-10% of the total customers. Control group customers are selected at random to be given a specific experience or even shown nothing at all, in order to continue to build a training set of data which is uncoupled from the rest of the experiences given to customers. Customers should not be aware they are in a control group.

Next, a propensity to refer score is determined for the selected customer, step 304. The propensity to refer score (hereinafter simply referred to as “score”) provides an indication of how likely the customer is to refer another individual or organization to the merchant. In some embodiments, the score can indicate how likely the customer is to refer another individual or organization to a different merchant, which may in some sense be related to the first merchant, for example, by belonging to the same corporate group or by being collaboration partners in some aspect. The score can be expressed, for example, as a percentage (i.e., “we predict this individual has a x % likelihood to refer”) or as a binary decision (i.e., “this customer has a high/low propensity to refer”). This is a design choice that can be easily implemented by those having ordinary skill in the art. However, it should be realized that the score can be expressed in any format or scale.

Typically, the score is determined using a prediction model which has been pre-built using machine learning techniques applied to historical data (e.g., a Random Forest, XGBoost or Deep Learning model trained on data taken from the last n months of customer data for the merchant or merchants). When such a model has been suitably trained and tested, it can be fed a new customer's details (whose data it has not necessarily previously seen) and can calculate a predicted score based on its previous training. The training process involves “feature engineering,” that is, identifying valuable features from amongst the historical customer data and turning those features into values which can be easily trained against. In particular the control group data from customers who were shown an offer that was not determined by the prediction itself is useful here to make sure the training is not biased.

As an example implementation, a model trained against historical data and tuned specifically for a given Merchant to have a known performance expressed in terms of “AUC” (Area Under the Curve) or “F1” Score from testing is hosted on a computing device behind an API (Application Programming Interface) such that the customer data can be fed into the model. The model returns a propensity score (or, in some embodiment, simply a binary flag for high or low propensity) which is then used to adjust the customer's segment allocation and the message(s) and the customer experience they receive as a result by the Intermediary Partner 104.

The model tuning process is one where various parameters of the chosen model or even the choice of model type itself are compared, tested and optimized using a known training set to give the best results possible for a specific merchant. The AUC or F1 score are well understood performance metrics for machine learning models which represent measures of a model's precision, accuracy, and recall.

Care must be taken here to ensure the training process is automated and does not take too long (for example being refreshed on a weekly basis) and also that the features selected can be processed and predicted against in a fraction of a second, such that a typical customer does not notice (or need to wait) for the next step in their customer journey. The typical speed of such a device returning a decision is less than approximately 150 ms.

Once the customer's score has been determined, the customer is added to a segment of customers having a similar score, step 306. In some embodiments, the merchant 102 can also define various business rules, which can be considered when deciding to which segment a particular customer should be added. The segments can be refined to any level, based on the situation at hand. For example, if a merchant is only interested in sending out two types of marketing message, a cutoff threshold can be determined where customers with scores below a certain percentage get one type of message, whereas customers with scores above that percentage get the other type of message. In other embodiments, the segment can be further refined and be based on factors in addition to the score alone. For example, segments can be based on the likelihood to refer, in combination with the customer being located in a particular geographical area, or being of a certain age, gender, demographic etc., in case the merchant desires to more specific marketing campaigns. In most implementations where the customer is “present” during this process, the message sent to the customer is shown to the customer immediately such that they can take action—refer their friend(s), make a follow-on purchase, and/or sign up for a newsletter etc. —and their state and segment recorded for future interactions and reporting of the performance of the program.

Next, the method checks whether there are any more customers whose data should be analyzed, step 308 (e.g., if another customer interacts with the merchant's web application). If there are more customers, the method proceeds to step 302 and continues as outlined above. If all customers have been processed, the method continues to step 310, in which the intermediary agent 104 sends different messages to the different segments of customers. For example, customers in a segment with a score at 90% or above may receive a refer a friend message. On the other hand, customers in a segment having a score at 10% or may receive a different marketing message or action from the merchant such as asking for a review or offering to sign up for the newsletter or being given a reward for the next purchase or offered a cross-sell discount. The messages can be sent out using various types of conventional channels, such as “online” (as in during the Customer Experience of the customer purchasing, checking their account or browsing the merchant's site) or through various messaging channels (e.g., Whatsapp, SMS, Email, Facebook, etc.), all of which are familiar to those having ordinary skill in the art. This ends the method 300.

As was mentioned above, this method can be evaluated, for example, by examining how a control segment of customers performed in relation to the customers that were selected as participants in this method. Typical metrics which might be used to quantify the behavior of one segment over another might be: the amount of sharing with friends which happens in the high propensity to the low segment or control segment, or how much repeat purchasing or overall how much revenue is generated per customer in different segments. Ultimately the Merchant will choose metrics which make sense to their business, but any combinations of these measures are possible. Based on the results, the method can be run again with a different set of possible messages, an updated set of training data or even a different set of features or model tuning parameters (aiming to choose the best model configuration to give the best F1 or ROC AUC scores for a given merchant based on training data) and thus be optimized over time to find a reliable and performant model that provides a good fit for the merchant's needs. Some embodiments might go one step further to aim to recommend the message which suits the customer at that particular moment in time—rather than simply predicting a propensity to refer. Such models (“Causal models”) influence the outcome of the data which is also used to train the model and so have to be carefully designed to avoid circular bias. In an example embodiment there might be a “catalog” of suitable offers, each with a different purpose and whose implementation has been previously separately optimized. The model would choose the preferred “next action” for a customer to take given everything known about that customer up to now and in doing so optimizing margin or revenue growth that the Merchant prefers.

As was also mentioned above, there may be various types of data or various structural forms of data that over time prove to be of greater or less value for the performance of the method. For example, example data parameters can be put into different structural forms (e.g., an Order Date could be turned into features: “time of day,” “day of week,” “season of year,” which may impact the model performance). The parameters of the model (for example the depth of a Random Forest model or various other “hyper parameters” can also be chosen or tweaked to optimize the model's stability or accuracy over a long period of training data. For example, a model which has a very high performance requirement on speed of prediction might be tuned in a way which achieves that at the expense of accuracy. Another model where accuracy is prioritized might use a different ML technique or feature set in order to improve that accuracy. Different models can be chosen, or layered models can be used (separate models which together vote on the outcome), to meet the required stability and target performance threshold for the overall model. There may also be improvements made in machine learning techniques, which when applied to the initial data sets and model, could make the method perform better. However, any such modification is considered to be variations that fall well within the capabilities of those having ordinary skill in the art, and will therefore not be described here.

It should also be noted that while customers have generally been described above as individuals, the same general principles are also applicable to customers that are organizations (e.g., companies or various associations). And it should further be noted that “customers,” as used throughout this specification, typically refer to representations of customers in an electronic format, such as records in a relational database management system (RDBMS), just to mention one possible representation. Various alternative representations will be apparent to those having ordinary skill in the art.

### CONCLUSION

The present invention may be a system, a method, and/or a computer program product at any possible technical detail level of integration. The computer program product may include a computer readable storage medium (or media) having computer readable program instructions thereon for causing a processor to conduct aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or conduct combinations of special purpose hardware and computer instructions.

What is claimed is:

1. A segmentation method, comprising:
selecting a customer from a set of customers associated with a merchant;
determining a propensity to refer score for the selected customer;
associating the customer with a customer segment among two or more customer segments, wherein the associating is done at least in part based on the propensity to refer score; and
providing a customized message to the customers in at least one customer segment.

2. The method of claim 1, wherein different customer segments are provided with differently customized messages, and wherein the customized messages are intended to encourage the customers in the customer segment to take an action.

3. The method of claim 1, wherein the propensity to refer score represents a likelihood for the customer to refer another potential customer to a merchant.

4. The method of claim 1, wherein the propensity to refer score is based on data collected from several data sources and is representative of one or more of: the customer's purchase history, the customer's demographic, the customer's psychographic and the customer's psychological behavior.

5. The method of claim 4, wherein the data sources include one or more of: order data, device data, personally identifiable information, observed data, and other customer behavioral data.

6. The method of claim 1, further comprising:
evaluating an impact on the customers' behaviors from the customized message sent to the at least one customer segment, with respect to a customer control group, and
changing the contents and/or format of the customized message to influence the customers' behaviors in response to the customized message.

7. The method of claim 1, further comprising:
in response to a customer performing an action specified in the message, providing a reward to the customer.

8. The method of claim 7, wherein the action specified in the message is to refer a potential customer to a merchant, and wherein the potential customer is also provided with a reward.

9. The method of claim 1, wherein machine learning techniques are used to determine the propensity to refer score.

10. A system for segmenting customers, comprising:
a processor; and
a memory storing instructions that when executed by the processor cause the processor to perform the following operations:
selecting a customer from a set of customers associated with a merchant;
determining a propensity to refer score for the selected customer;
associating the customer with a customer segment among two or more customer segments, wherein the associating is done at least in part based on the propensity to refer score; and
providing a customized message to the customers in at least one customer segment.

11. A computer program product for segmenting customers, comprising a non-transitory computer readable storage medium containing instructions that when executed by a processor cause the processor to:
select a customer from a set of customers associated with a merchant;
determine a propensity to refer score for the selected customer;
associate the customer with a customer segment among two or more customer segments, wherein the associating is done at least in part based on the propensity to refer score; and
provide a customized message to the customers in at least one customer segment.
